(19) United States
(12) Patent Application Publication
(10) Pub. No.: US 2013/0227026 A1
(43) Pub. Date: Aug. 29, 2013

(54) LOCATION PROFILES

(71) Applicants: Santosh Jayaram, San Francisco, CA (US); Peter Goettner, San Francisco, CA (US); Antonio Altamirano, Menlo Park, CA (US)

(72) Inventors: Santosh Jayaram, San Francisco, CA (US); Peter Goettner, San Francisco, CA (US); Antonio Altamirano, Menlo Park, CA (US)

(73) Assignee: Daemonic Labs, San Francisco, CA (US)

(21) Appl. No.: 13/601,540

(22) Filed: Aug. 31, 2012

Related U.S. Application Data
(60) Provisional application No. 61/605,151, filed on Feb. 29, 2012.

(51) Int. Cl. G06F 15/16

(52) U.S. Cl. 709/205

(57) ABSTRACT

Disclosed herein are location profiles created in some embodiments by aggregating data from users, processing the data into a location profile, and using the location profile for a variety of uses including but not limited to ranking search results based on characteristics derived from analyzing posts associated with the user profile, and providing a feed of posted associated with a location when the location is followed by a user.

### CROSS REFERENCE TO RELATED APPLICATIONS

This application Claims the benefit of the filing date of U.S. provisional patent application Ser. No. 61/605,151, filed Feb. 29, 2012, entitled “Location Profiles” which is incorporated by reference herein in its entirety.

### BACKGROUND

1. Technical Field

The present disclosure relates to aggregating data from users of a social media service into a location profile and using the location profile to return search results to users based on an expected characteristic of a future visit.

2. Introduction

Social media, which can generically be described as media for social interaction, includes the creation of profiles for users based upon websites that they visit, purchases that they make on-line, friends that they associate with through their network of friends, and/or from comments that they leave on other people's social media pages. These user profiles contain a wealth of information that can be used to target advertisements and content to these users in effort to enrich the user's digital experience. These profiles benefit advertisers and content providers as well since reports can also be generated from the information in these user profiles to figure out how effective advertising and content have been targeted. However, the user profiles are user-centric and thus can be improved.

### SUMMARY

The present technology involves the creation of profiles for locations from a collection of social media content, including but not limited to user posts associated with the location. In some instances the users have visited the location and their posts regarding the location can be used to derive a profile associated with the location. Such location profiles can be used as a factor in returning search results, used to target advertisements to likely visitors of the location, used to provide user reviews or commentary related to the location, and followed by a user such that information regarding the location can be distributed to the following user, etc.

In some embodiments of the present technology, digital postcards can be left at locations. These digital postcards, which contain similar information as a regularly mailed postcard, can be sent via a cellular phone or a home computer. Much like a user's posts can be used to create a user profile, the digital postcards also contain a wealth of information (i.e., metadata) that can be used to create a location profile when the user's posts are relevant to a location. As such, digital postcards having geo-location information associated therewith can be used to determine which users visited a current location, the user's age, income level, what that user thought of the location, which friends the user has that might be interested in that location, etc. Locations and/or posts can further be broken down into locations that are “timely” or “timeless,” wherein a timely location/post includes information that is most relevant during a particular period, whereas a timeless location/post includes information that is always relevant (at least in certain contexts). As multiple digital postcards are aggregated over time, a profile of that location can be developed.

In some embodiments user provided posts can be aggregated or collected for processing and/or analysis. The user provided posts can be posts provided in any context including posts made by users to a digital postcard service such as DABBLE™, or social media platforms such as FACEBOOK® and MYSPACE®. However, the user provided posts should include at least a location identifier and contextual data.

The location identifier can be any information that can be used to identify a location. In some embodiments the location information can be the name of a park, landmark, shop, building, university, business, etc. In some embodiments, the location information can include geographic location information such as Global Position System (GPS) coordinates, or triangulation information, or information about a Wi-Fi map. Each of these types of information can be used to determine an approximate geographic location.

In some embodiments, the geographic location information can be normalized into consistent data. For example, some user provided posts might include the name of a landmark, while other posts include metadata including GPS coordinates. These different data types can be converted into a common system (all user recognizable names of landmarks, buildings, stores, businesses, etc. or all GPS coordinates, etc.). This conversion can be accomplished with the help of a geo-location service by looking up GPS coordinates from a user recognizable name, or a reverse lookup by providing GPS coordinates and receiving the user recognizable name of the location.

The aggregated user provided posts can be processed to group the user provided posts into location profiles for the locations (whether by GPS coordinates or user recognizable names).

Once the user provided posts have been processed into location profiles, the location profiles can be followed or subscribed to just as if they were a friend's or contact's profile in conventional social media applications. Updates to the location profile can be published to a wall, posted as a feed, such as a TWITTER® feed, or pushed by an RSS service.

In some embodiments, the location profile can further be analyzed to determine patterns, and characteristics associated with user provided posts and the location profile as a whole. For example, posts can be analyzed using a timeliness heuristic to determine whether a post should be considered a timely post or a timeless post. A timeless post can be a post that was made by a user that is considered a tourist to the location, or posts made by a famous person. A post can be considered timely if a larger number of posts than normal are being posted to the same location, or if posts are being added to the location profile at a greater rate than a determined threshold rate. Additionally, locations themselves can be considered timeless or timely based on a percentage of the total number of individual posts that have been classified as timeless or timely.

In some embodiments, the determined patterns or characteristics of posts or locations can be used to influence the ranking or ordering of search results. For example, if a tourist is looking for landmarks, timeless locations can be ranked higher in the search results. Or if a tourist is looking for a restaurant, a timeless restaurant can be ranked higher in the search results. Conversely, if a user is not a tourist, it can be more desirable to return search results that are not timeless, or to return search results that are timely. It should be appreciated that other patterns or classifications can be determined and that these patterns or classification can be used to arrange data such as search results.

In some embodiments, patterns or classifications resulting from processing the data included in the location profiles can by made available via an application programming interface (API) so that third parties can access this information and use it to enrich their services. For example, location review or profiling sites such as YELP® can supplement their information with information accessible via the APIs. These services might extract additional user reviews based on the posts associated with the user profile, or might filter recommendations or search results, etc.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following descriptions and appended claims, or can be learned by the practice of the principles set forth herein.

This brief summary has been provided so that the nature of the technology may be understood quickly. A more complete understanding of the technology can be obtained by reference to the following descriptions of the preferred embodiments thereof in connection with the drawings, which together form a complete specification.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary system for creating and sharing digital postcards;

FIG. 2 illustrates an exemplary embodiment for the generation of location profiles;

FIG. 3 illustrates an exemplary embodiment for the generation of user profiles;

FIG. 4 illustrates an exemplary embodiment of a user interface element;

FIG. 5 illustrates an exemplary embodiment of various functions of the user interface element;

FIG. 6 illustrates an exemplary embodiment of referring various locations to a user based upon that user's profile;

FIG. 7 illustrates an exemplary embodiment of one of the functions of the user interface element;

FIG. 8 illustrates a flow diagram showing the steps involved in an embodiment of the present technology concerning matching user profiles to location profiles, referring users to locations that match their profiles, creating incentives for users to visit those locations, and the ability of the present technology to assess the effectiveness of those incentives; and

FIG. 9 illustrates an exemplary system embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

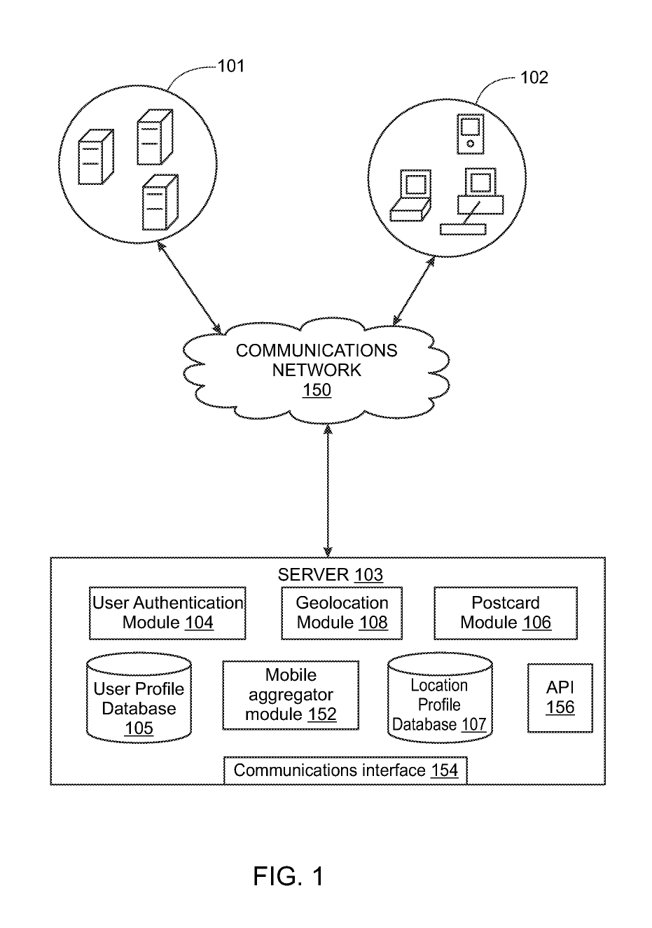

FIG. 1 illustrates an exemplary system for creating and sharing digital postcards. System 100 can be configured for use on a network such as that illustrated in FIG. 1. However, the present technology is also applicable to a wide variety of network configurations that facilitate the intercommunication of electronic devices and/or servers. For example, each of the components of system 100 in FIG. 1 can be implemented in a localized or distributed fashion in a network. As illustrated, system 100 includes individual devices 102, servers of other social media outlets 101, and the present technology server 103 all communicating with each other through communications network 150.

Individual devices 102 are configured to transmit and receive data through communication networks 150. In one embodiment, individual devices 102 can create and transmit digital postcards. In another embodiment, individual devices 102 can receive digital postcards or metadata associated with digital postcards for presentation to the user. Exemplary individual devices 102 include portable electronic devices and personal computing devices such as cellular phones, including smart phones, laptop computers, or desktop computers. This list is not meant to be exhaustive of all of the different devices that can be included in the list of individual devices 102, but is merely used to show examples of the different types of individual devices 102 that can be included in with the present technology.

Individual devices 102 can communicate with servers 101 through the communications network 150. Servers 101 can be configured to store data belonging to social media outlets such as Facebook, Twitter, LinkedIn, or other social media outlets, etc. Servers 101 can store user information regarding the location, gender, education attainment level, or likes/interests, etc. associated with members of the social media outlets. These examples are not meant to include an exhaustive list of all types of servers 101 that can be included in this present technology, but is offered to provide an example of the type of server 101 that can be used for this present technology. As shown in FIG. 1, the communications network 150 can serve as a transmission medium between server 101, individual device 102, and the present technology server 103, thus allowing any or all of these devices to receive data from any other device coupled to the network.

In one embodiment, the present technology server 103 can include a user authentication module 104 configured to allow the user to create an account. For example, the user authentication module 104 can be configured to prompt a user to enter a username and password. In other examples, a user can be prompted to enter further information, including the user's location, age, gender, profession, marital status, etc. The user authentication module 104 can be configured to store this information in a user profile database 105 configured to store metadata associated with a user.

In one embodiment, the server 103 can also include a communications interface 154. The communications interface 154 generally governs and manages the user input and system output. There is no restriction on operating on any particular hardware arrangement and therefore the basic features here may easily be substituted for improved hardware or firmware arrangements as they are developed.

The user authentication module 104 can further be configured to communicate with other hardware coupled to communications network 150. In one embodiment, user authentication module 104 can communicate with servers 101 to locate additional information associated with the user. For example, the user authentication module 104 can be configured to prompt a user for authorization to download user metadata stored on servers 101 such as a user's Facebook, Twitter, or LinkedIn account. If a user authorizes the download (either one time download or a subscription for this and future downloads), the user authentication module can communicate with the servers 101 and extract data from the servers 101. In some embodiments of the present technology, information that can be extracted can include information associated with a user that was not previously provided by a user, such as their location, age, marital status, profession, etc. The profile aggregator module 152 can be configured to aggregate or store this information in user profile database 105. The profile aggregator module 152 can be further configured to aggregate or store all other information associated with each user into the appropriate user profile database 105 associated with that user. In some examples, the user profile database 105 is configured to store information associated with this user.

Present technology server 103 can also include a postcard module 106 configured to create and post digital postcards. In one embodiment, present technology server 103 can transmit the created digital postcards to an individual device 102 that has been associated with the user. For example, a particular individual device can be associated with a user by having the user log into his account on present technology server 103. In some examples, this can be accomplished by having the postcard module 106 prompt a user to enter information on the digital postcard application such as a user name or password.

In some embodiments, users can be prompted to enter information on the digital postcard application running on their individual device 102. The additional information can include their current location, the time of day, and a statement associated with their current location. The current location can be defined as the geographic location where the user is creating the postcard. The location can be described in a variety of ways such as a landmark, a street address, or GPS coordinates. The time of day can be defined as the time the user was at the location. The statement associated with the current location can be defined as a descriptive statement associated with that location. For example, the statement can be associated with the user's personal experience at that location. While in some embodiments the current location of a user is preferable, in some embodiments a user may be able to associate a postcard (or other social media post) with a selected location. Such embodiments can be especially useful in situations wherein a user's device does not have an adequate data connection at the time the postcard is created, or when a postcard is created after a user has left the location.

In some embodiments, the location data of the digital postcards can be determined using GPS or other navigation or location tracking/positioning services. In one example, location tracking/positioning services located on individual device 102 can be used in conjunction with location data received from the postcard module 106 to more particularly describe the physical location that the postcard originated from. The geolocation module 108 can perform the function of associating the tracking/positioning services located on individual device 102 with the location data received from the postcard module 106. For instance, the individual device 102 can refer to a mapping database to determine a landmark name, a street name, or the name of a point of interest that is from a given set of GPS coordinates. The geolocation module 108 can associate the information from the individual device against the mapping database to identify a correct name of the location. Thus, metadata associated with the physical locations of the digital postcards can be determined by using individual devices 102 which contain GPS or other technology that allows for location determination. In yet other examples, metadata associated with the physical location (e.g., landmark name, street name, name of point of interest, etc) can be received by individual device 102 from the postcard module 106 or alternatively interpolated from received data.

The postcard module 106 can be further configured to transmit information such as the location, statement associated with current location, the time of day, and the geographical coordinates of the location, from the digital postcard application to a location profile database 107. Location profile database 107 can receive this data and through the profile aggregator module 152 aggregate the data into a location profile associated with this physical location. The profile aggregator module can be further configured to aggregate or store all other information associated with each location into the appropriate location profile database 107 associated with that location. In other words, location profile database 107 can store location profiles, which are based on data from user profiles and individual postcards (which are user-based) that have been reorganized and grouped such that each profile focuses on a particular location. The postcard module 104 can also be configured to store information associated with locations that users have visited into the user profile database 105.

In some embodiments, patterns or classifications resulting from processing the data included in the location profiles can be made available via an application programming interface 156 (API) so that third parties can access this information and use it to enrich their services. For example, location review or profiling sites such as YELP® can supplement their information with information accessible via the APIs 156. These services might extract additional user reviews based on the posts associated with the user profile, or might filter recommendations or search results, etc.

In a further embodiment, users can also be prompted to associate pictures located on their individual device 102 with the postcard module 106. For example, the postcard module 108 can be configured to prompt the user to select a picture on their individual device to be associated with a statement related to that location. The postcard module can store these pictures in the location profile database 107, the user profile database 105, or both.

The postcard module 106 can also be configured to allow for users to associate with other users through networks and to share digital postcards. In a further embodiment, users can be prompted by the postcard module 106 to join networks of people that use the present technology. As explained above, each user has a user profile database. When a user chooses to associate with another user through a network, their user profiles become linked together through the database. As an example, user 1 has chosen to join a network with user 2. User 1's user profile database reflects that they are now associated or otherwise linked with user 2, and user 2's user profile database reflects that they are now associated or otherwise linked with user 1. The postcard module 106 can be configured to allow for users that are linked together through their user profile databases to be able to access certain information pertaining to the other. For example, users within the same network can view other user's digital postcards and leave comments on them. Users of the present technology can be prompted by the postcard module 106 to join already established networks, or to start a new network. The postcard module 106 can be configured to invite other users to join a network by sending notifications to other users. These notifications can be transmitted through available communication means on the devices, such as SMS text, chat, video message, e-mail, etc.

In some examples, the postcard module 106 can be configured to allow for users within the same network to be able to view other user's digital postcards through an application on their individual device 102. The postcard module 106 can be configured to allow users of the present technology to view the digital postcards that have been created by members of their networks. For example, the postcard module 106 can be configured to present a user with all the friends in their network. The user can then select a friend from his network and see all the postcards that the friend has created.

In addition to viewing postcards associated with other users in a network, the system can also be configured to allow a user to subscribe to the postcards associated with a certain location and to follow that location. The postcard module 106 can be configured to allow users to select a location and then access all of the postcards people drop at that location. Users can choose to associate with locations through their user device 102, in which the user can find locations by either using their GPS or other location determining software, or by entering the name of the location on their device. Users can choose the locations through the application on their individual device 102 that they want to follow. The postcard module 106 can be configured so that when a postcard is dropped at a location, the user that has associated with that location is notified via SMS or e-mail that a new postcard has been left at that location. Similar to users associating with other users through networks, users can also choose to associate with certain locations and be linked to those locations. When a user chooses to follow a location, their user number from their user database profile 105 is linked to the location profile database 107. When postcards are dropped at locations, the location profile database 107 can be configured so that all users linked to the location profile database 107 are notified via SMS or e-mail that a postcard has been dropped at that location. However, there can also be other methods for notifying users of new postcards that are associated with a place of interest to the user.

As an example, a user has chosen via their individual device to follow a protest happening at 5^{th} street and Mission in San Francisco. The user, using their individual device, locates this location, and chooses to follow this location. As more and more people leave postcards at the protest, the user is notified via SMS text or e-mail that postcards have been left at this location. The user is able to access all of these postcards that are associated with this location. In some examples, the postcards can be displayed or otherwise presented to the user on the user's individual device. These locations however can also be based on events (such as the protest). Thus, postcards related to a New Year's celebration (either in general or at a particular location) can be queried and stored under a profile in location profiles database.

In some embodiments, the locations available to the user can vary in scope. For example, a location can be a single store, a landmark, a chain of stores, a cross street, a city block, a city, or others. Thus, a particular postcard can be associated with multiple locations. For instance, a postcard taken at a coffee shop can be associated with the coffee shop, the neighborhood which the coffee shop is located in, or the coffee shop chain. In other embodiments, the user can create new locations based on user-selected parameters. For example, a user selects to follow a certain city, such as San Francisco and thus is able to access all postcards associated with this city. A user can further choose to associate with a certain neighborhood in San Francisco, such as the Mission District, and to be able to follow all postcards that have been left within the Mission District of San Francisco. If the user desires, the user can further refine his results by creating his own location to search for postcards on Mission Street between 3^{rd} and 5^{th} Streets. In other words, the locations available can be subsets of one another or alternatively, be user defined. In some examples, postcards associated with one location can be further associated with another location. For instance, postcards associated with individual Starbucks locations can also be associated with Starbucks as a company. These associations between postcards and locations can be generated via keywords or other metadata associated with the postcards or locations. These associations can also be generated by creating a virtual perimeter, also known as a geo-fence that is associated with a location. Postcards that have geographical coordinates within the geo-fence can be associated with the location.

The postcard module 106 can also be configured to allow for users to be able to view digital postcards of other users that are within a certain geographic vicinity of previously posted digital postcards. In this embodiment, the users are not within the same network. Users using an individual device 102 that contains GPS or other location determination technology can see if other postcards have been left within two miles of their current location. Users using an individual device 102 that does not contain GPS or other location determination technology can be prompted by the postcard module 106 to enter their current location via their current zip code. A two-mile perimeter is merely an example, as the postcard module can be modified to allow for other distances from their current location. In this embodiment, the user can view digital postcards that are within two miles of the current location to see digital postcards on other nearby locations.

As an example, a user visits a sandwich shop for lunch. He leaves a digital postcard at this location which states the name of the person who sent the postcard, the time that the postcard was left, and also includes a picture of the people he ate lunch with. Another user, across the street in an office building, who is not in the same network as the person visiting the sandwich shop, can access the digital postcard with his user device to see a review of the restaurant. The postcard module 106 can be configured to allow for privacy settings so that only those within a predetermined network can view their postcards.

The postcard module 106 can also be configured to allow for users to be able to view digital postcards of other users that are at the same geographic location that they are currently at. Users using an individual device 102 that contains GPS or other technology capable of determining a location, can see if other postcards have been left at the location they are currently at. Users using an individual device 102 that does not contain GPS or other technology capable of determining a location can be prompted by the postcard module 106 to enter their current location via the name of the location. In an example of this embodiment, a user at a restaurant can access the present technology application using his individual device to determine if other users have left postcards at this exact location. The user can then interpolate useful information from these postcards, for example, which meals are good/bad/expensive, etc.

The postcard module 106 can also be configured to allow for users to be able to leave comments on other users digital postcards. In an example of the present embodiment, a user using the present technology application on their individual device 102, can view other postcards of other users that are within their network, or postcards of other users that are not within their network, but within a certain geographic vicinity of their current location. The current user can leave a comment on that other user's digital postcard. In an example of the current embodiment, a user at the restaurant can access the present technology application on his individual device 102 and search for postcards associated with the present location using an embodiment of the postcard module 106 that allows for searching based upon geographic location. The user can then find a postcard associated with the current location and comment on that postcard. The original poster of the postcard will then be notified via SMS or e-mail that someone has commented on their postcard.

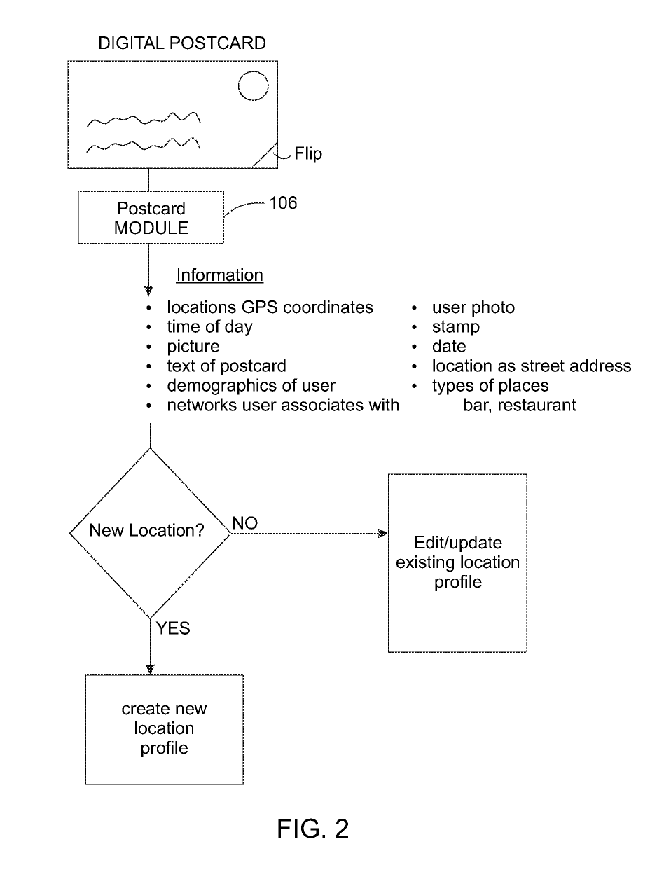

FIG. 2 illustrates an exemplary method embodiment for the generation of location profiles. As explained in FIG. 1, the postcard module 106 can be configured to store information (such as the location, statement associated with current location, the time of day, and the geographical coordinates of the location) from the digital postcard application in to a location profile in location profile database 107.

As more postcards are left at the same location, the location profile can contain more and more information from various users of the present technology. The postcard module 106 can be configured to create different location profiles for different locations based upon a location's geographical coordinates. In an example of the present technology, different users of the present technology leave postcards at the same location. The postcard module 106 is configured to store the information from each user's digital postcard in to the same location profile such that now the location profile of this location contains information from both users. In a further example of the present technology, one user leaves two digital postcards at two different locations. The postcard module 106 is configured to store the information associated with each different location in to its own separate location profile.

Over time, a location profile of a location will contain information from all of the digital postcards that were left at that current location. As an example, if 20 postcards are left at a current location, information from these 20 postcards, including the age, profession, marital status, time of day that the postcard was left, time of year that the postcard was left, etc. can be available within the location profile database of a particular location. In some examples, a user can specify what information to share with those in his network versus those outside his network by using privacy settings.

In some embodiment of the present technology, the content of the digital postcards left at locations can be reviewed and analyzed using contextual recognition software, or other software technology, to determine whether a user has had a positive or negative experience associated with a location. The software can be set to look for certain terms associated with a “good” or “bad” experience, such as the words “excellent,” “horrible,” “crowded,” “bad,” etc. The postcard module 106 can be configured to associate these terms with a location profile associated with a location such that over time a location can see the terms associated with their location. In other examples, an algorithm can be applied to the information in the postcard to generate additional metadata such as the user's experience or to ensure that the postcard is properly tagged and cataloged. For example, by lifting data or metadata from a postcard, the system can determine if the postcard should be retagged for the business next door. Other algorithms can also be applied to the postcard to check for accuracy, spell checking, the quality of the image, content, etc.

In another embodiment of the present technology, users of the present technology can rate their digital postcards on a scale of 1-10, with “1” associated with a negative experience associated with a location, and “10” associated with a positive experience associated with a location. The numerical values associated with the digital postcards left at locations can be reviewed and analyzed using software technology to determine whether a user has had a positive or negative experience associated with a location as determined by an average of their numerical values. The postcard module 106 can be configured to associate these numbers with a location profile database 107 such that over time, portraits of locations can be developed to enable locations to see how they are performing.

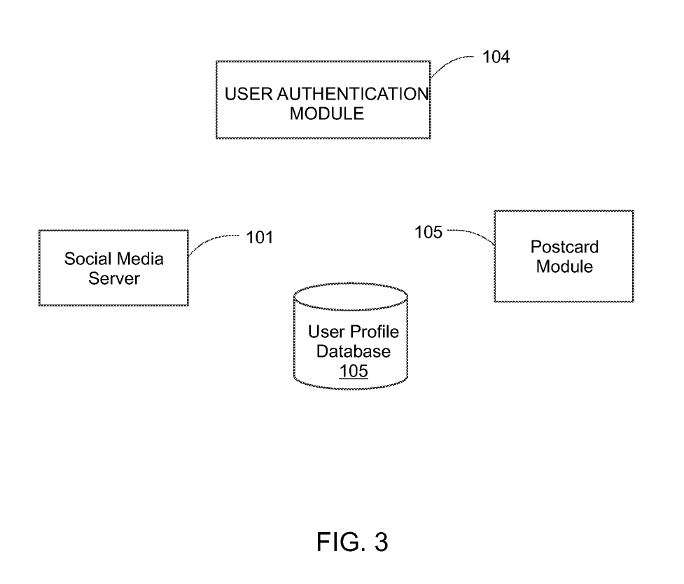

FIG. 3 illustrates an exemplary embodiment for the generation of user profiles. The user profile describes the user characteristics associated with a user. As described in FIG. 1., the present technology server can include a user authentication module 104 that can be configured to allow the user to create an account. The user authentication module 104 can be configured to prompt a user to enter a username and password. In addition, in some embodiments of the present technology, a user can be prompted to enter further information, including the user's location, age, gender, profession, marital status, etc. The user authentication module 104 can be configured to store this information in a user profile database 105 which stores the information associated with this user.

The user profile database 105 also can include information from social media server 101. The user authentication module 104 can be configured to communicate with a user's Facebook, Twitter, Yelp, LinkedIn, etc. account. The user profile database 105 can be configured to take information from these accounts and place this information in to the user profile database associated with a particular user.

The user profile database 105 can also include information from postcard module 106. Postcard module 106 can be configured to allow information from user's digital postcards to be placed into a user's user profile database 105. In an example of this embodiment, the location where a user has left digital postcards, the time of day that a postcard was left, or the text associated with a postcard can be placed into a user's user profile database 105. Over time and as a particular user uses the present technology at various locations, the information taken from those postcards is placed into the user's user profile database, and a portrait of the user can be created.

In some embodiments, the user's particular location profile can be cross-referenced against the user profile database 105 such that locations can be referred to users based upon an expected characteristic of a future visit. A comparison module can be configured to search for consistent terms between the location profile database and the user profile database. The comparison module can then be configured to cross-reference these consistent terms against other locations that have databases within the present technology server. The present technology server can then present to the user through the application those other locations that are consistent with the user's user profile database. By comparing databases between users and locations and matching similarities, search results can be sent to users based on an expected characteristic of a future visit.

For example, a user that has visited 5 different coffee shops in the past and left postcards at each of these coffee shops uses the application associated with the present technology. The comparison module can be configured to cross reference the user's likes such as coffee shops with locations having a location profile in the profile database to suggest other coffee shops to the user. The application refers the user to another different coffee shop 1 mile away from the user's current location. In this case, the present technology server cross-referenced this user's profile database against locations that have a location profile. A location the user hadn't visited that is consistent with the user's profile is referred to the user based upon an expected characteristic of a future visit.

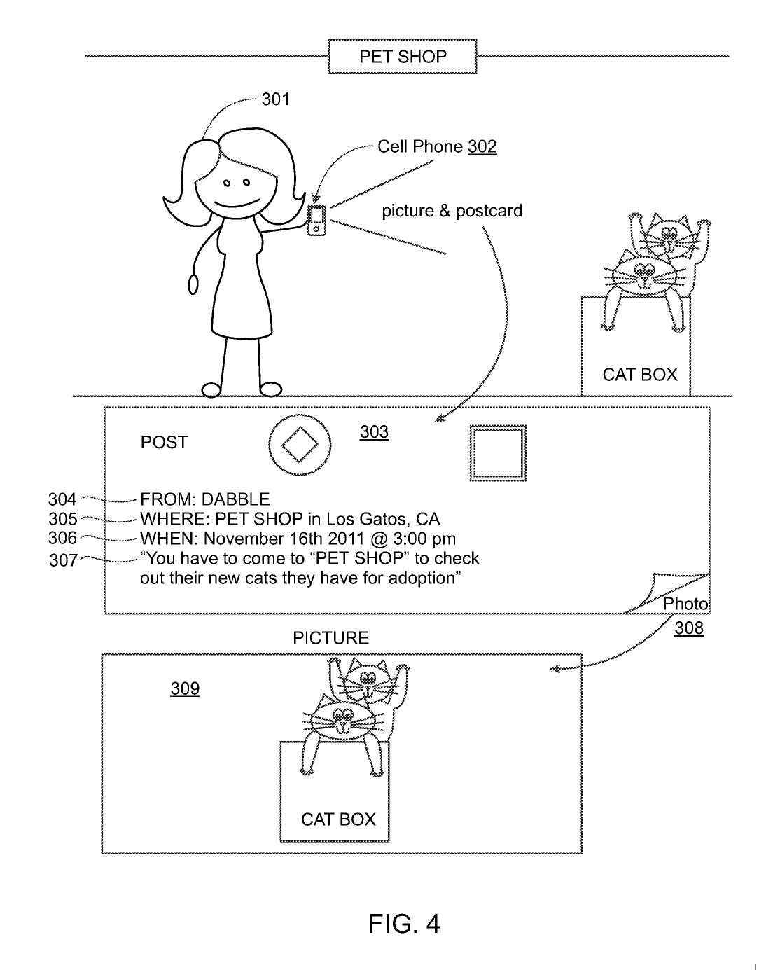

FIG. 4 illustrates an exemplary method embodiment of the way in which a user generates a user interface element. FIG. 4 is used as a reference to show how a user would create a digital postcard using the present technology application on their individual device. In FIG. 4, a user 301 enters a location “PET SHOP” and takes a picture with his individual user device 302 of 2 cats that are in “CAT BOX.” On the user's individual user device 302, an interface appears, resembling a postcard 303, except in digital format. The digital postcard states whom is sending the digital postcard 304, where the postcard is being sent from 305, when the postcard was sent 306, as well as text associated with the postcard 307. The text can be related to anything that the user would like to associate with the picture or event. After pressing the photo button 308, the user is given the option of which picture 309 they want to associate with the postcard. This picture can be any picture that the user wishes to associate with the location that is located on their individual device. Alternatively, the individual device can be set to take a picture at this moment in time.

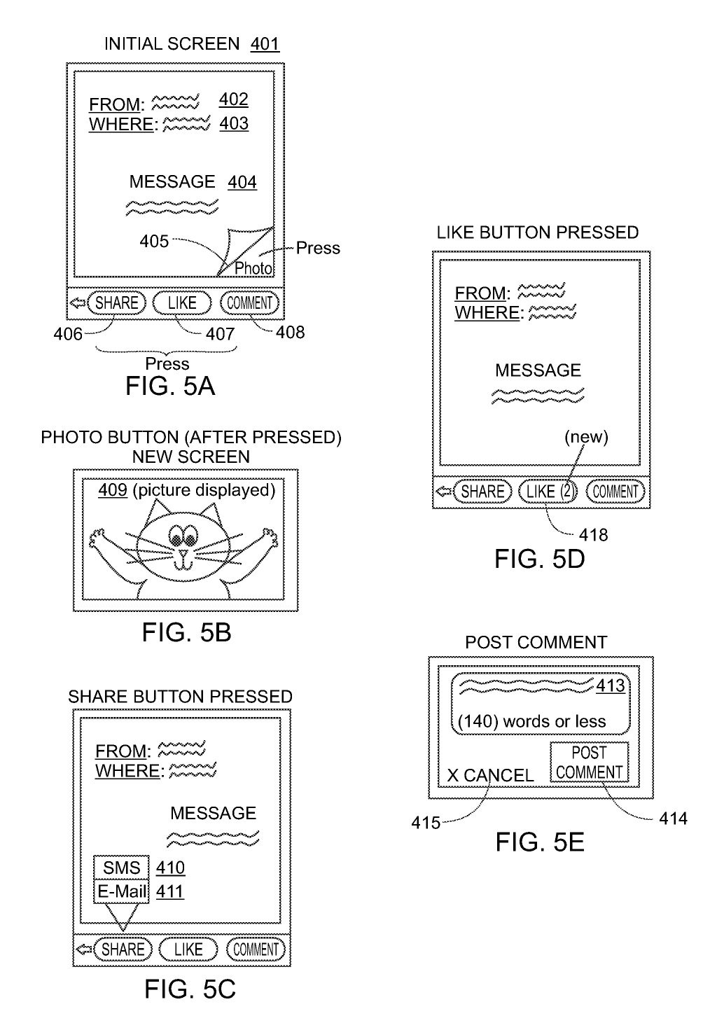

FIG. 5 illustrates an exemplary embodiment of various functions of the user interface element. In the “Initial Screen” 401, the initial interface element is revealed. In this interface element, who sent the postcard 402 is entered, where 403 the user sent the postcard from is entered, as well as a message 404 associated with the postcard is entered. Other examples can include fewer or more fields for information from the user. In yet other examples, some of the fields can be mandatory while others are optional. Pressing “PHOTO” 405 allows the user to attach a photo associated with the postcard. After pressing the “PHOTO” 405 button, the user is taken to a new screen 409, in which the user can select which picture they want to associate with their postcard. After pressing the “SHARE” 406 button on the initial interface, “SMS” 410 appears, giving the user the option of texting their postcard to a friend. “E-MAIL” 411 also appears, further allowing the user the ability to share their postcard with someone via e-mail. The “LIKE” 407 button on the initial screen allows other users within the network to express their satisfaction with a postcard. When another user presses “LIKE” 407 on one's postcard, a number 412 appears, corresponding to the number of “LIKES” a particular postcard has. For example, if two users within a network “LIKE” a particular postcard, the numerical value in the “LIKE” box will reveal the number “2”. When the “COMMENT” 408 button is pressed, a user within a network will be able to leave a comment 413 associated with the picture. After writing their comment 413, a user has the option of posting the comment 414 or cancelling their comment 415.

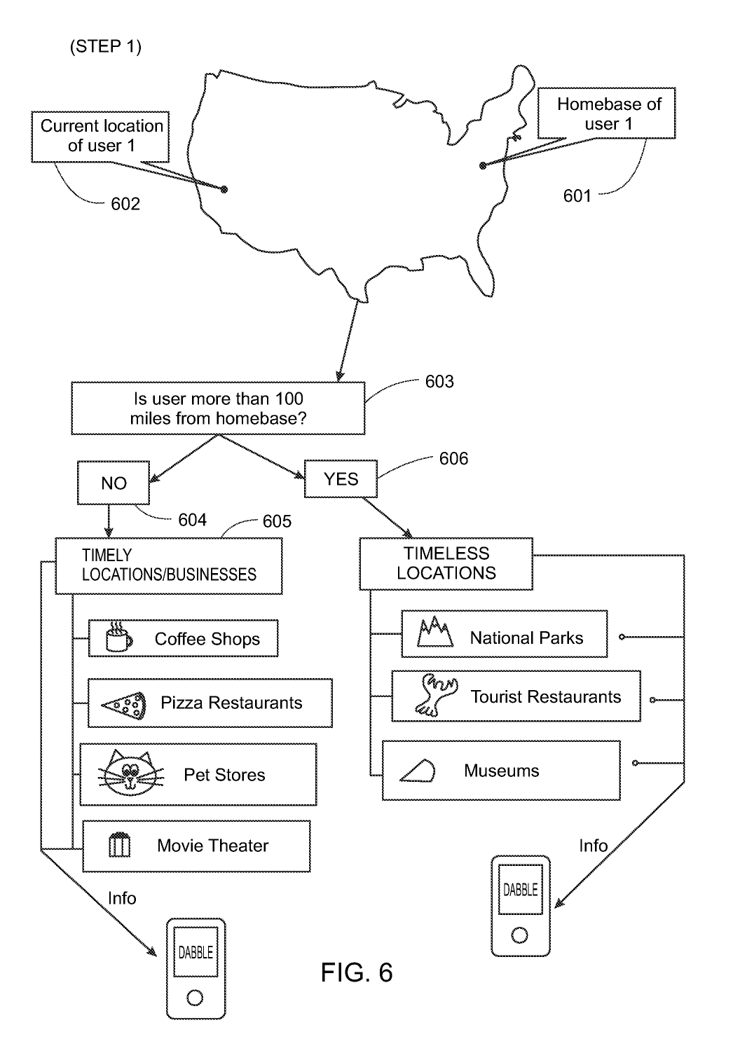

FIG. 6 illustrates a flow diagram showing the steps involved in an aspect of the present technology concerning referring various locations to a user based upon that user's profile. As a first step, the “home base” 601 of the user is determined. This “home base” is the location that a user has identified as their primary location from their user profile. Using GPS or other location technology, the current location of a user 602 is identified. The present technology determines whether the person is more than 100 miles from their current “home base.” 100 miles is used merely as an example, as this number can be changed to 50, 75, 200 miles, or other distance value based upon preference. If it is determined that a user is less than 100 miles from their “home base,” that user's current location can be deemed to be “timely.” Using the user's previously developed user profile, locations can be referred to the user that correspond to “timely” 605 locations that the user might be interested in visiting.

If, though, it is determined that 606 the user is more than 100 miles from their “home base,” that person will fall in to the “timeless” category. “Timeless” locations are those locations that tourists would be most interested in visiting. Likely, the user of the present technology has not previously visited and left digital postcards at locations that are considered “timeless”, as these locations are further away from their “home base” and they are thus least likely to visit them. As such, predetermined “timeless” locations can be referred to a user. In both the “timely” and “timeless” category, locations are referred to the user's individual device using this present technology. Thus, the concept of “timely” and “timeless” can be used to filter and search for the locations to present to the user.

In a further embodiment, the number of words from the text of a postcard can be used to determine whether a location is timely or timeless. The number of words from each postcard left at a location can be located in the location profile database associated with each location. In an example of this embodiment, posts from postcards from locations that average more than 50 words can be deemed timeless locations, as users tend to write more words about timeless locations. 50 words is used merely as an example, as the present technology can be configured to determine that timeless locations can encompass 20 words, 80 words, or 100 words, etc. The timeless locations that have text of 50 words or more can then be referred to users, as described in the embodiment above.

In a further embodiment, the length of time between postcards being left at locations can be used to determine whether those locations are timely or timeless. The length of time between postcards being left at a location can be located in the location profile database associated with each location. As an example, if it is determined that a postcard is left at a location ten times a month, this location can be deemed timely, as timely locations can have more postcards left at them as compared to timeless postcards. Ten times a month was used merely as an example, as the present technology can be configured to determine that 5 times, 20 times, or 50 times a month, etc. is considered timely.

In a further embodiment, location profiles can be further classified according to other user characteristics. For example, using the current technology, the time of day that postcards are left at locations can be associated with those locations in the location profile database. Over time and as more digital postcards are left at locations, a portrait of a location can be developed such that a location profile can include the time of day that visitors, for example, visit that location. In another example, in a given year, a location will be able to know if, for example, more postcards were left at that location during the summer months as opposed to the winter months. In a further example, a location profile will include, based upon the user characteristics of those users that have left postcards at the locations, the income level of customers to that location (this is presuming that the income level of the users is provided).

In another example, information associated with locations can have public application programming interfaces to allow access to this data by outsiders. For example, those locations that have had profiles associated with their location can determine the demographics of their customer base. Also, marketing or advertising agencies can know the types of customers that leave postcards at various restaurants. Also, parents looking to keep track of their children that use this technology will be able to see which locations their children have visited and what time they visited those locations. Furthermore, businesses looking to keep track of their employees will also be able to see which locations their employees visited and what time they visited those locations.

In some embodiments, the types of people that visit locations can be determined, for example, to determine if famous people visit certain locations. Similar to contextual recognition software as discussed in the embodiment above, names of celebrities can be referenced against the content of the digital postcards to associate celebrity names with locations. For example, if Kevin Spacey frequents a particular bar in New York City and users of the present technology post digital postcards referencing Kevin Spacey, other users of the present technology would be able to know their likelihood of seeing Kevin Spacey at that location. This same example can be used for athletes that visit restaurants close to sports stadiums after games, or for local newscasters that are seen at church in Kansas City, Kansas. In other examples, the system gives priority to postcards generated by celebrities or other group of people so that their postcards are presented first to the user.

In some embodiments, users after having left a digital postcard at a location can view that location on their individual device in the future to determine if other users of the present technology have left postcards there. Using this embodiment of the present technology, users can see which other members of the networks that they associate, or members from networks that they don't associate with, have gone to the locations where digital postcards have been left.

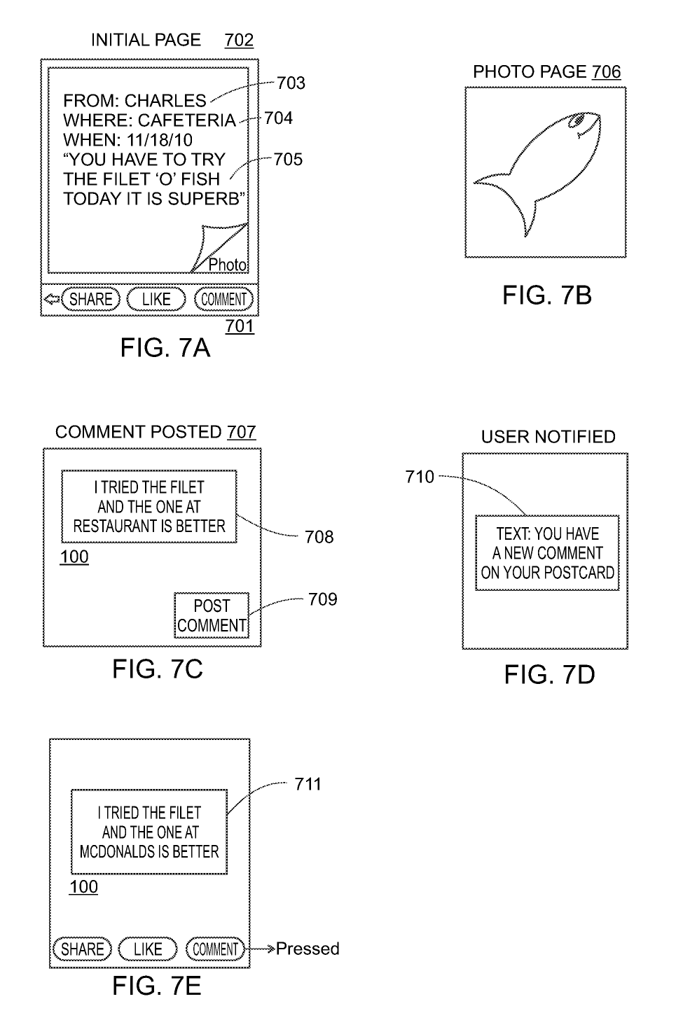

FIG. 7 illustrates an exemplary embodiment of one of the functions of the user interface element. FIG. 7 illustrates how, within a network of friends that are using the present technology, one friend is able to leave a comment on another's friend's previously posted digital postcard. After having pressed the 701 comment button on the initial user interface as described in FIG. 4, the comment page 707 appears. The comment page originates from the previously posted digital postcard. In this example, “Charles” 703 was in the “cafeteria” 704. Charles' postcard was commenting 705 on the meal that day, stating, “You have to try the filet of fish today it is superb.” The picture associated with this postcard is at 706. To leave a comment on this digital postcard, a user, having pressed the comment button 701, is taken to the comment posted 707 interface. The user can post a comment 708 associated with this digital postcard, in this example the comment reading, “I tried the filet and the one at restaurant is better.” The user can post this comment by pressing the “Post Comment” button at 709. The user of the present technology that left the initial postcard is then sent an SMS message or e-mail 710, indicating that a comment has been left on their digital postcard. The user that left the initial digital postcard can then look at the comment on their postcard 711 to see what a member of their community has said about their postcard.

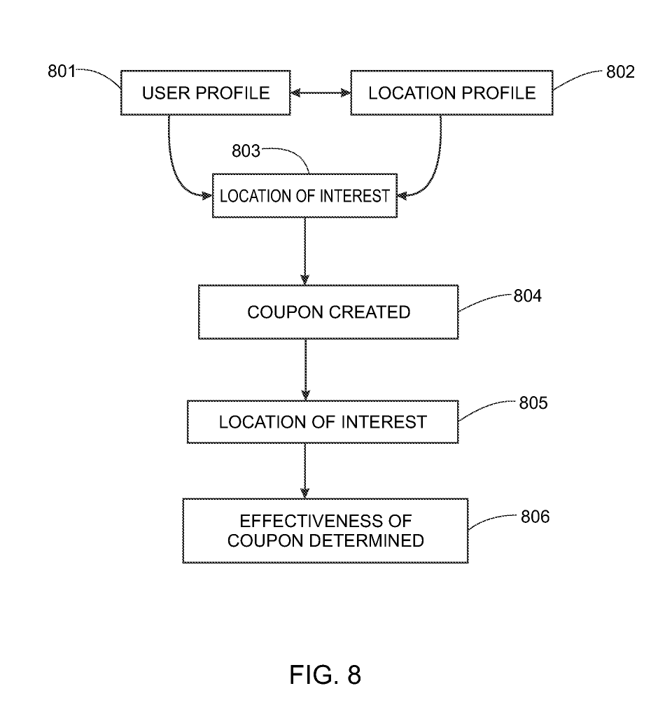

FIG. 8 illustrates a flow diagram showing the steps involved in an embodiment of the present technology concerning matching user profiles to location profiles, referring users to locations that match their profiles, creating incentives for users to visit those locations, and/or the ability of the present technology to assess the effectiveness of those incentives. As described above in FIG. 3, a user, through the use of this present technology, can create a user profile 801. This user profile can reflect user characteristics about the user. These user characteristics can entail information taken from their user profile from when the user signed up for the present technology, the networks that the user associates with, and from the information taken from that user's digital postcard history. As described in FIG. 2, a location (or event), after having digital postcards generated and associated with the location (or event), also develops a location profile 802. A user's profile can be matched with a location profile such that locations can be referred to users that the user would have an interest in, described herein as the “location of interest” 803. This can be done by the matching information contained with the present technology databases between the locations and the users. Databases in the present technology can include user characteristics such as age and content of previous digital postcards. Location profiles also include user characteristics such as the age of people that have visited that location and the content of digital postcards left at that location. By comparing databases between users and locations and matching similarities, search results can be sent to users based on an expected characteristic of a future visit.

In some embodiments, a user that has previously left digital postcards at a coffee shop has a profile reflective of their interest in coffee. A location in close proximity to the user's “home base” that sells coffee and that has a location profile indicative of this can, through this present technology, let the user know of the location and its products.

In some embodiments, a user that is more than 100 miles from their home base, and that has previously posted digital postcards reflective of an interest in national parks, can be referred national parks that are located within a certain vicinity of the user's current location. The national parks that are within a certain distance of the user's current location can be sent to the user's individual device for viewing by the user.

Furthermore, the present technology can provide to the user an incentive, such as a coupon 804, to entice the user to visit the location 805. The present technology can then track the effectiveness of this coupon 806, as the present technology will be able to track whether or not the user used the coupon or not.

In some embodiments, locations can use the present technology to let networks on the present technology know of certain events that are happening. For example, if in a network of friends using the current technology, digital postcards have been left at a video game store, advertisements can be sent to the network indicating the arrival of a new video game. Also, for example, in a network of friends associated with a certain location, information can be sent to members of that network, indicating to those members a particular news event associated with that location, such as a storm approaching, a parade happening in the middle of town or a speaker coming to town. In this example, the video game store will be able to determine how many members of the current network viewed the coupon, or the city will be able to determine how many members of the network viewed its emergency announcement.

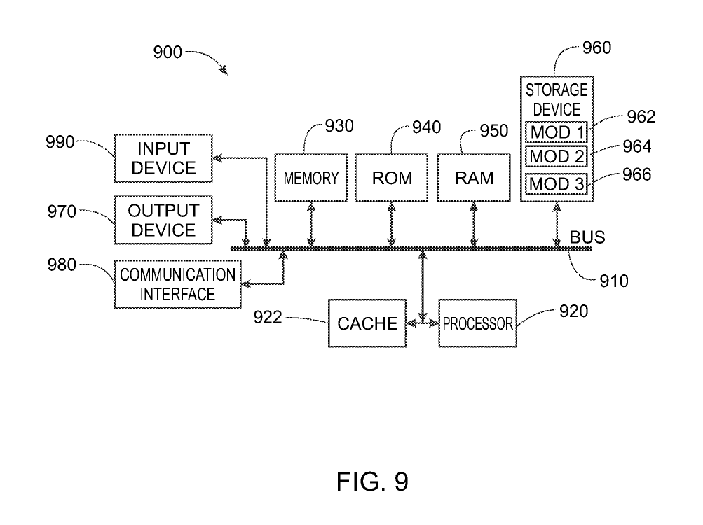

With reference to FIG. 9, an exemplary system 900 includes a general-purpose computing device 900, including a processing unit (CPU or processor) 920 and a system bus 910 that couples various system components including the system memory 930 such as read only memory (ROM) 940 and random access memory (RAM) 950 to the processor 920. The system 900 can include a cache 922 of high speed memory connected directly with, in close proximity to, or integrated as part of the processor 920. The system 900 copies data from the memory 930 and/or the storage device 960 to the cache 922 for quick access by the processor 920. In this way, the cache provides a performance boost that avoids processor 920 delays while waiting for data. These and other modules can control or be configured to control the processor 920 to perform various actions. Other system memory 930 may be available for use as well. The memory 930 can include multiple different types of memory with different performance characteristics. It can be appreciated that the disclosure may operate on a computing device 900 with more than one processor 920 or on a group or cluster of computing devices networked together to provide greater processing capability. The processor 920 can include any general purpose processor and a hardware module or software module, such as module 1 962, module 2 964, and module 3 966 stored in storage device 960, configured to control the processor 920 as well as a special-purpose processor where software instructions are incorporated into the actual processor design. The processor 920 may essentially be a completely self-contained computing system, containing multiple cores or processors, a bus, memory controller, cache, etc. A multi-core processor may be symmetric or asymmetric.

The system bus 910 may be any of several types of bus structures including a memory bus or memory controller, a peripheral bus, and a local bus using any of a variety of bus architectures. A basic input/output (BIOS) stored in ROM 940 or the like, may provide the basic routine that helps to transfer information between elements within the computing device 900, such as during start-up. The computing device 900 further includes storage devices 960 such as a hard disk drive, a magnetic disk drive, an optical disk drive, tape drive or the like. The storage device 960 can include software modules 962, 964, 966 for controlling the processor 920. Other hardware or software modules are contemplated. The storage device 960 is connected to the system bus 910 by a drive interface. The drives and the associated computer readable storage media provide nonvolatile storage of computer readable instructions, data structures, program modules and other data for the computing device 900. In one aspect, a hardware module that performs a particular function includes the software component stored in a non-transitory computer-readable medium in connection with the necessary hardware components, such as the processor 920, bus 910, display 970, and so forth, to carry out the function. The basic components are known to those of skill in the art and appropriate variations are contemplated depending on the type of device, such as whether the device 900 is a small, handheld computing device, a desktop computer, or a computer server.

Although the exemplary embodiment described herein employs the hard disk 960, it should be appreciated by those skilled in the art that other types of computer readable media which can store data that are accessible by a computer, such as magnetic cassettes, flash memory cards, digital versatile disks, cartridges, random access memories (RAMs) 950, read only memory (ROM) 940, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 900, an input device 990 represents any number of input mechanisms, such as a microphone for speech, a touch-sensitive screen for gesture or graphical input, keyboard, mouse, motion input, speech and so forth. An output device 970 can also be one or more of a number of output mechanisms known to those of skill in the art. In some instances, multimodal systems enable a user to provide multiple types of input to communicate with the computing device 900. The communications interface 980 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 920. The functions these blocks represent may be provided through the use of either shared or dedicated hardware, including, but not limited to, hardware capable of executing software and hardware, such as a processor 920, that is purpose-built to operate as an equivalent to software executing on a general purpose processor. For example the functions of one or more processors presented in FIG. 9 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 940 for storing software performing the operations discussed below, and random access memory (RAM) 950 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 900 shown in FIG. 9 can practice all or part of the recited methods, can be a part of the recited systems, and/or can operate according to instructions in the recited non-transitory computer-readable storage media. Such logical operations can be implemented as modules configured to control the processor 920 to perform particular functions according to the programming of the module. For example, FIG. 9 illustrates three modules Mod1 962, Mod2 964 and Mod3 966 which are modules configured to control the processor 920. These modules may be stored on the storage device 960 and loaded into RAM 950 or memory 930 at runtime or may be stored as would be known in the art in other computer-readable memory locations.

1. A computer-implemented method comprising:
aggregating user provided posts collected from a population of users at a server, the user provided posts including at least a location identifier and contextual data; and
processing the aggregated user provided posts into a location profile, the processing comprising:
grouping the user provided posts associated with approximately the same location identifier into the location profile.

2. The computer-implemented method of claim 1, further comprising:
transmitting each user provided post associated with the approximately the same location identifier as post by that location.

3. The computer-implemented method of claim 2, wherein a following user follows the stream of posts by the location.

4. The computer-implemented method of claim 1 further comprising:
applying a timeliness heuristic to the posts of the location profile.

5. The computer-implemented method of claim 4, wherein the timeliness heuristic determines that a post should be classified as timeless when a user having a home base that is greater than a determined distance from the geographic location provided the post associated with the location profile.

6. The computer-implemented method of claim 4, wherein the timeliness heuristic determines that a post should be classified as timeless when a user that is considered a famous user provided the post.

7. The computer-implemented method of claim 4, wherein the timeliness heuristic determines that a post should be classified as timely when posts from a collection of users, exceeding a determined number, are received at a rate, exceeding a determined rate.

8. The computer-implemented method of claim 1, further comprising:
applying a timeliness heuristic to the location profile.

9. The computer-implemented method of claim 8, wherein the location associated with the location profile is considered a timeless location when a percentage, greater than a determined percentage, of the total posts in the location profile are have been determined to be timeless.

10. The computer-implemented method of claim 1, wherein the processing the aggregated user provided posts into a location profile further comprises:
normalizing the location identifiers into locations known to a reverse geo-coding lookup service.

11. The computer-implemented method of claim 4, further comprising:
providing an API configured to allow third-party access to timeliness data as determined by the timeliness heuristic applied to the posts of the location profile, wherein upon receiving a request for post timeliness data through the API timely or timeless posts associated with a location can be returned to the third-party.

12. The computer-implemented method of claim 8, further comprising:
providing an API configured to allow third-party access to timeliness data as determined by the timeliness heuristic applied to the location profile, wherein upon receiving a request timeliness data through the API timely or timeless locations can be returned to the third-party.

13. A system comprising:
a profile aggregation module configured to aggregate user provided posts collected from a population of users at a server in a user profile database, the user provided posts including at least a location identifier and contextual data, and further configured to process the aggregated user provided posts into a location profile by grouping the user provided posts associated with approximately the same location identifier into the location profile; and
a location profile database configured to store the location profiles.

14. The system of claim 13, further comprising:
a communications interface configured to transmit each user provided post associated with the approximately the same location identifier as post by that location.

15. The system of claim 13 wherein the profile aggregation module is further configured to apply a timeliness heuristic to the posts of the location profile stored in the location profile database.

16. The system of claim 13 wherein the profile aggregation module is further configured to apply a timeliness heuristic to the location profile.

17. The system of claim 13, wherein the profile aggregation module is further configured to process the aggregated user provided posts into a location profile by normalizing the location identifiers into locations known to a reverse geo-coding lookup service.

18. The system of claim 15, further comprising:
an API configured to allow third-party access to timeliness data as determined by the timeliness heuristic applied to the posts of the location profile, wherein upon receiving a request for post timeliness data through the API timely or timeless posts associated with a location can be returned to the third-party.

19. The system of claim 16, further comprising:
an API configured to allow third-party access to timeliness data as determined by the timeliness heuristic applied to the location profile, wherein upon receiving a request timeliness data through the API timely or timeless locations can be returned to the third-party.

20. A computer-readable medium having computer-readable instructions stored thereon effective for causing a computer to perform a method comprising:
aggregating user provided posts collected from a population of users at a server, the user provided posts including at least a location identifier and contextual data; and
processing the aggregated user provided posts into a location profile, the processing comprising:
normalizing the location identifiers into locations known to a reverse geo-coding lookup service, and
grouping the user provided posts associated with approximately the same location known to the reverse geo-coding lookup service.
